(19) United States
(12) Patent Application Publication
(10) Pub. No.: US 2014/0228481 A1
(43) Pub. Date: Aug. 14, 2014

(54) FIBER SIZING AGENT COMPOSITION

(71) Applicant: SANYO CHEMICAL INDUSTRIES, LTD, KYOTO (JP)

(72) Inventors: Masahito Inoue, Kyoto (JP); Kazuki Aoki, Kyoto (JP)

(73) Assignee: SANYO CHEMICAL INDUSTRIES, LTD., KYOTO (JP)

(21) Appl. No.: 14/345,953

(22) PCT Filed: Sep. 20, 2012
(86) PCT No.: PCT/JP2012/005983

§ 371 Date: Mar. 20, 2014

(30) Foreign Application Priority Data
Sep. 22, 2011 (JP) 2011-206743

(51) Int. Cl. D06M 15/55; D06M 15/572; D06M 13/188; C08J 5/06; D06M 13/402; D06M 13/224; D06M 15/507; D06M 15/53

(52) U.S. Cl. CPC D06M 15/55; D06M 15/507; D06M 15/572; D06M 15/53; C08J 5/06; D06M 13/402; D06M 13/2243; D06M 13/188; D06M 2200/40; C08J 2363/00
USPC 523/222; 528/87; 528/195; 525/531; 528/84; 528/103; 252/8.83; 428/367

(57) ABSTRACT

A fiber sizing agent is described, which is capable of imparting sufficient sizing properties and fiber spreading properties to reinforced fiber bundles for producing fiber-reinforced composite materials. A fiber sizing agent composition (E) includes a sizing agent (A) having a viscosity of 50 to 3,000 Pa·s at 35° C., and has a thixotropic index of 3 to 15. The sizing agent (A) is preferably an epoxy resin, a polyester resin, a polyurethane resin, a polyether resin or a vinyl ester resin.

### FIELD OF THE INVENTION

The invention relates to a fiber sizing agent. More specifically, the invention relates to a fiber sizing agent used in fiber-reinforced composite materials.

### DESCRIPTION OF THE RELATED ART

Composite materials of various kinds of fibers and matrix resins such as unsaturated polyester resin, phenol resin, epoxy resin and polypropylene resin and various kinds of fibers are widely utilized in fields such as building materials, sports appliances, leisure appliances, and aircrafts, etc. The fibers used in these composite materials are exemplified by carbon fiber, glass fiber, aramid fiber, ceramic fiber, metallic fiber, mineral fiber, and slug fiber, etc. In order to suppress end breakage or fluffing, these fibers are processed into bundle-shaped (fiber bundle) for use, with a sizing agent or the like.

Before combining this fiber bundle with the matrix resin, a process of increasing the bundle width is performed. By doing so, impregnability of the matrix resin is increased, and thin and high-grade prepreg may be made. In this way, it is demanded that the fiber bundle has good sizing properties and good fiber spreading properties (the wider the width of the fiber bundle, the better the fiber spreading properties), and these properties are controlled by performance of the sizing agent. However, the sizing properties and the fiber spreading properties are essentially contrary to each other, and it is difficult for them to coexist at high levels.

In Patent Document 1, a test is performed in which a water-soluble vinyl copolymer formed from a specific monomer is used as a sizing agent.

Meanwhile, in Patent Document 2, in order to impart sufficient fiber spreading properties, a test is performed in which a sizing agent obtained by combining a specific ester compound with an epoxy resin is used.

### PRIOR-ART DOCUMENTS

### Patent Documents

Patent Document 1: Japan Patent Publication No. Hei 9-291480

Patent Document 2: Japan Patent Publication No. Hei 9-31851

### SUMMARY OF THE INVENTION

### Problems to be Solved by the Invention

Though the method in Patent Document 1 is capable of forming a fiber bundle having high sizing properties, due to the too high viscosity of the vinyl ester, sufficient fiber spreading properties cannot be imparted.

Though the method in Patent Document 2 is good for fiber spreading properties, due to the overly low viscosity of the sizing agent, sufficient sizing properties are not exhibited.

In this way, no conventional sizing agent was able to satisfy both sizing properties and impregnability.

An object of the invention is to provide a fiber sizing agent capable of imparting sufficient sizing properties and fiber spreading properties to reinforced fiber bundles for producing fiber-reinforced composite materials.

### Means for Solving the Problems

As a result of investigation for the purpose of achieving the aforementioned object, the present inventors have attained the invention.

That is, the invention includes: a fiber sizing agent composition (E) that includes a sizing agent (A) having a viscosity of 50 to 3,000 Pa·s at 35° C. and has a thixotropic index of 3 to 15, a fiber sizing agent aqueous solution (S) obtained by dissolving or dispersing the above fiber sizing agent composition (E) in an aqueous medium, fiber bundles obtained by processing various kinds of fibers with the above fiber sizing agent composition (E) or fiber sizing agent aqueous solution (S), a composite intermediate formed from the above fiber bundle and a matrix resin, and a fiber-reinforced composite material obtained by molding the above composite intermediate.

### Effects of the Invention

The fiber bundle processed by the fiber sizing agent composition of the invention is good in sizing properties and fiber spreading properties, thus achieving effects of no fluffing or end breakage, excellent impregnability and improved grade.

### DESCRIPTION OF THE EMBODIMENTS

A fiber sizing agent composition (E) of the invention includes a sizing agent (A) having a viscosity of 50 to 3,000 Pa·s at 35° C.

If the viscosity of (A) at 35° C. is less than 50 Pa·s, the sizing properties of (E) are insufficient. If the viscosity of (A) at 35° C. is more than 3,000 Pa·s, the fiber spreading properties of (E) are insufficient.

The viscosity of (A) at 35° C. is preferably 100 to 2,000 Pa·s, and more preferably 200 to 1,500 Pa·s.

The viscosity of (A) at 35° C. is measured by reading the viscosity after 20 minutes from the beginning of the measurement using a Brookfield BH type viscometer at a rotational speed of 0.3 rpm. In regard to the rotor, an appropriate combination is selected from a measurement upper limit table attached to the apparatus and the measurement is performed with a reading in the range of 30 to 70.

The sizing agent (A) is exemplified by epoxy resin, polyester resin, polyurethane resin, polyether resin, vinyl ester resin, and a mixed resin thereof, etc.

The epoxy resin is exemplified by bisphenol A epoxy resin, bisphenol F epoxy resin, bisphenol S epoxy resin, phenol novolac epoxy resin, cresol novolac epoxy resin, glycidyl ester epoxy resin, glycidylamine epoxy resin, polyalkylene glycol-based epoxy resin, polyurethane-based epoxy resin, and a glycidylated product of a fatty alcohol, etc.

The polyester resin is exemplified by a linear polyester formed from a diol and a dibasic acid, a lactone ring-opening polymer, and a polyhydroxycarboxylic acid, etc.

The diol is exemplified by C₂-C₃₀ dihydric alcohols, such as ethylene glycol, propylene glycol, butanediol, neopentylglycol; aliphatic alkanediols prepared by adding a C₂-C₄ alkylene oxide to these diols; alkylene oxide adducts of primary alkylamines such as methylamine, ethylamine, propylamine, octylamine and dodecylamine; and alkylene oxide adducts of aromatic ring-containing dihydric phenols such as bisphenol A, bisphenol S and cresol, etc. These diols may be used alone or in combination of two or more kinds thereof.

The dibasic acid is exemplified by C₂-C₂₄ dicarboxylic acids, and specifically, C₂-C₂₄ saturated aliphatic dicarboxylic acids (oxalic acid, malonic acid, succinic acid, adipic acid, and sebacic acid, etc.), C₂-C₂₄ unsaturated aliphatic carboxylic acids (maleic acid and fumaric acid, etc.), C₂-C₂₄ aromatic dicarboxylic acids (phthalic acid, terephthalic acid, and isophthalic acid, etc.), and C₂-C₂₄ dicarboxylic anhydrides (maleic anhydride and phthalic anhydride, etc.), etc.

The lactone ring-opening polymer is exemplified by those obtained by ring-opening polymerization of lactones such as C₃-C₁₂ mono-lactones (having one ester group in the ring, such as β-propiolactone, γ-butyrolactone, δ-valerolactone, and ε-caprolactone, etc.) using a catalyst such as a metallic oxide, an organometallic compound or the like.

The polyhydroxycarboxylic acid is exemplified by one obtained by dehydration condensation of a hydroxy carboxylic acid (such as glycolic acid and lactic acid, etc.).

The polyurethane resin is exemplified by one derived from a polymeric polyol, an organic diisocyanate, and if necessary, a chain extender and/or a crosslinker.

The above polymeric polyol is exemplified by polyester polyols (e.g., polyethylene adipate diol, polybutylene adipate diol, polyethylene butylene adipate diol, polyneopentyl adipate diol, polyneopentyl terephthalate diol, polycaprolactone diol, polyvalerolactone diol, and polyhexamethylene carbonate diol, etc.), polyether polyols [polyoxyethylene glycol, polyoxypropylene glycol, polyoxyethyleneoxypropylene glycol, polyoxytetramethylene glycol, and C₂-C₄ alkylene oxide adducts of bisphenols, etc.], etc.

Specific examples of the organic diisocyanate are, e.g., aromatic diisocyanates, such as 2,4′- or 4,4′-diphenylmethane diisocyanate (MDI), 2,4- or 2,6-tolylene diisocyanate (TDI), 4,4′ -dibenzyldiisocyanate, 1,3- or 1,4-phenylene diisocyanate, 1,5-naphthylene diisocyanate, and xylylene diisocyanate, etc.; aliphatic diisocyanates, such as ethylene diisocyanate, hexamethylene diisocyanate (HDI), lysine diisocyanate, etc.; alicyclic diisocyanates, such as isophorone diisocyanate (IPDI), and 4,4′-dicyclo-hexylmethane diisocyanate, etc.; and a mixture of two or more kinds thereof.

The polyether resin is exemplified by polyoxyethylene glycol, polyoxypropylene glycol, polyoxyethyleneoxypropylene glycol, polyoxytetramethylene glycol, and C₂-C₄ alkylene oxide adducts of bisphenols, etc.

The vinyl ester resin is exemplified by esters of the above epoxy resins and acrylic acid or methacrylic acid, etc.

Among the sizing agent (A), epoxy resin, polyester resin and vinyl ester resin are preferred, bisphenol A epoxy resin, bisphenol F epoxy resin, bisphenol S epoxy resin, polyalkylene glycol-based epoxy resin, and a polyester of an alkylene oxide adduct of an aromatic dihydric phenol, an aliphatic alkanediol and an unsaturated aliphatic dicarboxylic acid are more preferred, and bisphenol A epoxy resin is even more preferred.

The fiber sizing agent composition (E) of the invention has a thixotropic index (hereinafter simply referred to as “TI value”) of 3 to 15. The TI value of (E) refers to a numerical value calculated by the following calculation formula (1).

TI value of (E)=(E0.3 rpm)/(E3 rpm) (1)

(E0.3 rpm): viscosity of (E) at 35° C. (measured by a Brookfield BH type viscometer at a rotational speed of 0.3 rpm)

(E3 rpm): viscosity of (E) at 35° C. (measured by a Brookfield BH type viscometer at a rotational speed of 3 rpm)

Moreover, the viscosity of (E) at 35° C. is a numerical value read after 20 minutes from the beginning of the measurement.

In regard to the rotor, an appropriate combination is selected from a measurement upper limit table attached to the apparatus and the measurement is performed with a reading in the range of 30 to 70.

If the TI value of (E) is less than 3, it is unfavorable because the sizing properties and the fiber spreading properties are not both good. If the TI value of (E) is more than 15, it is unfavorable since gelation occurs and the sizing properties deteriorate.

The TI value of (E) is preferably 3 to 10, and more preferably 3.5 to 7.

The method of making the TI value of (E) be 3 to 15 is not particularly limited. However, it is preferred that (E) includes a thixotropy imparting agent (B) since it will be easy to adjust the TI value of (E) to the range of 3 to 15.

The thixotropy imparting agent (B) is exemplified by a fatty acid amide, a fatty acid ester, a fatty acid salt, a polyolefin oxide, and a mixture thereof, etc.

The fatty acid amide has a carbon number of 10 to 50, and is exemplified by an aliphatic monocarboxylic acid amide, an N-substituted aliphatic monocarboxylic acid amide, an aliphatic biscarboxylic acid amide, and an N-substituted aliphatic carboxylic acid bisamide, etc.

Specific examples of the aliphatic monocarboxylic acid amide are, e.g., lauric acid amide, palmitic acid amide, oleamide, stearic acid amide, erucic acid amide, behenic acid amide, ricinoleic acid amide, and hydroxystearic acid amide, etc.

Specific examples of the N-substituted aliphatic monocarboxylic acid amide are, e.g., N-oleylpalmitic acid amide, N-oleyloleic acid amide, N-oleylstearic acid amide, N-stearyloleic acid amide, N-stearylstearic acid amide, N-stearylerucic acid amide, methylolstearic acid amide, and methylolbehenic acid amide, etc.

Specific examples of the aliphatic biscarboxylic acid amide are, e.g., ethylene-bisstearic acid amide, ethylenebislauric acid amide, ethylenebiscapric acid amide, ethylenebisoleic acid amide, ethylenebiserucic acid amide, ethylenebisbehenic acid amide, ethylenebisisostearic acid amide, ethylenebishydroxystearic acid amide, butylenebisstearic acid amide, hexamethylenebisoleic acid amide, hexamethylenebisstearic acid amide, hexamethylenebisbehenic acid amide, and hexamethylenebishydroxystearic acid amide, etc.

Specific examples of the N-substituted aliphatic carboxylic acid bisamide are, e.g., N,N′-dioleylsebacic acid bisamide, N,N′-dioleyladipic acid bisamide, N,N′-distearyladipic acid bisamide, and N,N′-distearylsebacic acid bisamide, etc.

The fatty acid ester has a carbon number of 19 to 60, and is exemplified by an ester of a polyhydric alcohol and a fatty acid. Specific examples of such ester include hydrogenated castor oil, an ester of glycerin and stearic acid, an ester of glycerin and oleic acid, an ester of sorbitan and stearic acid, and an ester of sorbitan and oleic acid, etc.

The fatty acid salt is exemplified by a salt of a C₁₂-C₂₂ fatty acid and a metal such as lithium, sodium, potassium, barium or aluminum, etc.

The C₁₂-C₂₂ fatty acid is exemplified by lauric acid, myristic acid, palmitic acid, palmitoleic acid, margaric acid, stearic acid, oleic acid, vaccenic acid, linoleic acid, linolenic acid, arachidic acid, behenic acid, and 12-hydroxystearic acid, etc.

The polyolefin oxide is prepared by oxidizing, with oxygen, a polymer formed from one or more monomers selected from the group consisting of ethylene, propylene, 1-butene and 1-pentene, or is prepared by subjecting the same to an acid grafting treatment. The polyolefin oxide has an acid value of 1 to 85 mgKOH/g, and a weight-average molecular weight of 1,000 to 4,500. A specific example is mentioned in paragraphs 0019 to 0027 of Japan Patent Publication No. 2008-266448.

Among (B), the fatty acid amides are preferred, aliphatic monocarboxylic acid amides are more preferred, and lauric acid amide, palmitic acid amide, oleamide and stearic acid amide are even more preferred.

The fiber sizing agent composition (E) of the invention may be used in combination with a surfactant (C) or another additive (D) if necessary.

The surfactant (C) is exemplified by well-known surfactants such as a non-ionic surfactant, an anionic surfactant, a cationic surfactant, and an amphoteric surfactant, etc. Two or more kinds thereof may be used in combination.

The non-ionic surfactant is exemplified by an alkylene oxide [having a carbon number of 2 to 4, such as ethylene oxide, propylene oxide, 1,2-butylene oxide, 1,4-butylene oxide, or a combination of two or more kinds thereof; the same rule applies to the following description for the surfactant (C)] addition-type non-ionic surfactant [e.g., an alkylene oxide adduct [weight-average molecular weight (simply referred to as Mw hereinafter)=158-20,000] of a higher alcohol (with a carbon number of 8 to 18) or a higher fatty acid (with a carbon number of 12 to 24), one prepared by reacting an alkylene oxide adduct (Mw=500-5,000) of an alkylphenol (with a carbon number of 10 to 20), a styrenated phenol (with a carbon number of 14 to 62), a styrenated cumylphenol or a styrenated cresol (with a carbon number of 15 to 61), or a polyalkylene glycol (Mw=150-6,000), with a higher fatty acid; an alkylene oxide adduct (Mw=350-10,000) of an esterified product obtained by reacting a polyhydric (di- to octa-hydric or higher hydric) alcohol (with a carbon number of 2 to 32, e.g., ethylene glycol, propylene glycol, glycerin, pentaerythritol or sorbitan, etc.) with a higher fatty acid (with a carbon number of 12 to 24, e.g., lauric acid and stearic acid), an alkylene oxide adduct (Mw=200-30,000) of a higher fatty acid amide, an alkylene oxide adduct (Mw=220-30,000) of a polyhydric (di- to octa-hydric or higher hydric) alcohol alkyl (with a carbon number of 8 to 60) ether, etc.], a polyhydric (di- to octa-hydric or higher hydric) alcohol (with a carbon number of 2 to 32) type non-ionic surfactant [e.g., a polyhydric alcohol fatty acid (with a carbon number of 8 to 36) ester, a polyhydric alcohol alkyl (with a carbon number of 7 to 32) ether, or a fatty acid (with a carbon number of 8 to 32) alkanolamide, etc.], and so on.

The anionic surfactant is exemplified by a carboxylic acid (C₈-C₂₂ saturated or unsaturated fatty acid) or a salt thereof (a salt of sodium, potassium, ammonium, or a alkanolamine, etc.), a salt of a carboxymethylated product of a C₈-C₁₆ fatty alcohol, a C₈-C₂₄ fatty alcohol ether carboxylic acid [e.g., a carboxymethylated product of an alkylene oxide (1-10 moles) adduct of a C₈-C₂₄ (preferably C₁₀-C₁₈) fatty alcohol], a sulfate ester salt [a higher alcohol sulfate ester salt (a sulfate ester salt of a C₈-C₁₈ fatty acid alcohol, etc.)], a higher alkyl ether sulfate ester salt [a sulfate ester salt of an ethylene oxide (1 to 10 moles) adduct of a C₈-C₁₈ fatty acid alcohol], a sulfated oil (neutralized product by sulfation of a natural unsaturated oil and fat or unsaturated wax without modification), a sulfated fatty acid ester (neutralized product by sulfation of a lower alcohol ester of an unsaturated fatty acid), a sulfated olefin (neutralized product by sulfation of a C₁₂-C₁₈ olefin), a sulfonate [e.g., an alkylbenzene sulfonate, an alkylnaphthalene sulfonate, sulfosuccinic acid diester, an α-olefin (with a carbon number of 12 to 18) sulfonate, or the Igepon T type, etc.], a phosphate ester salt [e.g., a phosphate ester salt of a higher alcohol (with a carbon number of 8 to 60), a phosphate ester salt of an ethylene oxide adduct of a higher alcohol (with a carbon number of 8 to 60), or a phosphate ester salt of an ethylene oxide adduct of an alkyl (with a carbon number of 8 to 60) phenol, etc.], a sulfate ester salt (sodium salt, potassium salt, ammonium salt, or alkanolamine salt, etc.) of an alkylene oxide adduct (Mw=500-5,000) of an alkylphenol (with a carbon number of 10 to 20), a sulfate ester salt of an alkylene oxide adduct (Mw=500-5,000) of an arylalkylphenol [a styrenated phenol (with a carbon number of 14 to 62), a styrenated cumylphenol, or a styrenated cresol (with a carbon number of 15 to 61), etc.], and so on.

The cationic surfactant is exemplified by a quaternary ammonium salt-type surfactant [e.g., stearyl trimethyl ammonium chloride, behenyl trimethyl ammonium chloride, distearyl dimethyl ammonium chloride, and lanolin fatty acid aminopropylethyldimethylammonium ethylsulfate, etc.], and an amine salt-type surfactant [e.g., stearic acid diethylaminoethylamide lactate, dilaurylamine hydrochloride, or oleylamine lactate, etc.], etc.

The amphoteric surfactant is exemplified by a betaine-type amphoteric surfactant [e.g., coconut oil fatty acid amide propyl dimethyl betaine, lauryl dimethyl betaine, 2-alkyl-N-carboxymethyl-N-hydroxyethyl imidazolinium betaine, lauryl hydroxysulfobetaine, and sodium lauroylamidoethyl hydroxyethyl carboxymethylbetaine hydroxypropylphosphate, etc.], and an amino acid-type amphoteric surfactant [e.g., sodium β-laurylaminopropionate, etc.].

Among the surfactants (C), the anionic surfactant, the non-ionic surfactant, and a mixture of an anionic surfactant and a non-ionic surfactant are preferred, the alkylene oxide adduct of alkylphenol, the alkylene oxide adduct of arylalkylphenol, the sulfate ester salt of the alkylene oxide adduct of alkylphenol, the sulfate ester salt of the alkylene oxide adduct of arylalkylphenol, and a mixture thereof are more preferred, and the alkylene oxide (ethylene oxide or propylene oxide) adduct of arylalkylphenol, the sulfate ester salt of the alkylene oxide (ethylene oxide or propylene oxide) adduct of arylalkylphenol, and a mixture thereof are particularly preferred.

Examples of other additives (D) include a smoothing agent, a preservative, and an antioxidant, etc.

The smoothing agent is exemplified by a liquid paraffin, etc.

The preservative is exemplified by benzoic acid-type preservatives, salicylic acid-type preservatives, and sorbic acid-type preservatives, etc.

The antioxidant is exemplified by phenol-type antioxidants (e.g., 2,6-di-t-butyl-p-cresol, etc.), thiodipropionate-type antioxidants (e.g., dilauryl-3,3′-thiodipropionate, etc.), and phosphite-type antioxidants (e.g., triphenyl phosphite, etc.), etc.

The content of (A) in the fiber sizing agent composition (E) of the invention is preferably 50 to 100 wt %, more preferably 70 to 97 wt %, and particularly preferably 85 to 95 wt %, relative to the weight of (E). If the content of (A) is 50 wt % or more, the fiber spreading properties become sufficient, which is preferred.

The content of (B) in the fiber sizing agent composition (E) of the invention is preferably 0 to 50 wt %, more preferably 3 to 30 wt %, and particularly preferably 5 to 15 wt %, relative to the weight of (E).

If the content of (B) is 3 wt % or more, an addition effect is obtained, so that the sizing properties and the fiber spreading properties are both good. In addition, if the content of (B) is 50 wt % or less, the viscosity of (E) is appropriate, and the fiber spreading properties are sufficient.

The content of (C) in the fiber sizing agent composition (E) of the invention is preferably 0 to 40 wt %, more preferably 1 to 25 wt %, and particularly preferably 5 to 20 wt %, relative to the weight of (E).

The content of (D) in the fiber sizing agent composition (E) of the invention is preferably 0 to 60 wt %, more preferably 0.2 to 50 wt %, and particularly preferably 0.5 to 40 wt %, relative to the weight of (E).

The fabrication method of the fiber sizing agent composition (E) of the invention is not particularly limited. For example, it may be a fabrication method in which the sizing agent (A), the thixotropy imparting agent (B) (if necessary), the surfactant (C) and the another additive (D) are put into a mixing vessel in no particular sequence, and are stirred at preferably 20 to 90° C., and more preferably 40 to 90° C., until the mixture gets homogeneous.

The fiber sizing agent aqueous solution (S) of the invention is prepared by dissolving or dispersing the fiber sizing agent composition (E) of the invention in an aqueous medium.

Since (E) is dissolved or dispersed in the aqueous medium, it will be easy to set a deposition amount of (E) to the fiber bundle to an appropriate amount and to control the sizing properties and the fiber spreading properties.

Examples of the aqueous medium include well-known aqueous mediums, e.g., water and a hydrophilic organic solvent [e.g., C₁-C₄ lower alcohols (methanol, ethanol, and isopropanol, etc.), C₃-₆ ketones (acetone, ethyl methyl ketone, and methyl isobutyl ketone, etc.), C₂-C₆ glycols (ethylene glycol, propylene glycol, diethylene glycol, and triethylene glycol, etc.) and mono alkyl (with a carbon number of 1 to 2) ethers thereof, dimethylformamide, and C₃-0₅ alkyl acetates (methyl acetate and ethyl acetate, etc.), etc.]. Two or more kinds thereof may be used in combination. Among the aqueous media, from the viewpoint of safety and so on, water and a mixed solvent of a hydrophilic organic solvent and water are preferred, and water is more preferred.

From the viewpoint of cost and so on, it is preferred that the fiber sizing agent aqueous solution (S) of the invention is highly concentrated when circulating, and is low concentrated in fabrication of the fiber bundle. Specifically, due to circulation at a high concentration, the transport cost, the storage cost and so on are reduced, and due to processing of fiber at a low concentration, a fiber bundle excellent in both sizing properties and fiber spreading properties may be fabricated.

From the viewpoint of storage stability and so on, in cases where (S) is highly concentrated, the concentration (the content ratio of components other than the aqueous medium) is preferably 30 to 80 wt %, and more preferably 40 to 70 wt %.

From the viewpoint of the capability of setting the deposition amount of (E) to an appropriate amount in fabrication of the fiber bundle, etc., in cases where (S) is low concentrated, the concentration is preferably 0.5 to 15 wt %, and more preferably 1 to 10 wt %.

The fabrication method of the fiber sizing agent aqueous solution (S) of the invention is not particularly limited. For example, it may be a method in which the fiber sizing agent composition (E) of the invention obtained by the above method is put in an aqueous medium, followed by dissolving (E) or dispersing (E) by emulsification in the aqueous medium.

From the viewpoint of easiness of mixing, the temperature at which (E) is dissolved or dispersed by emulsification in the aqueous medium is preferably 20 to 90° C., and more preferably 40 to 90° C.

The time for dissolving (E) or dispersing (E) by emulsification in the aqueous medium is preferably 1 to 20 hours, and more preferably 2 to 10 hours.

When dissolving (E) or dispersing (E) by emulsification in the aqueous medium, a well-known mixing apparatus, dissolving apparatus or emulsify-dispersing apparatus may be used. Specifically, a stirring blade (blade shape: oar-type and three-stage paddle, etc.), a Nauta mixer [made by Hosokawa Micron Corporation], a ribbon mixer, a conical blender, a mortar mixer, a universal mixer {e.g., the universal mixer and stirrer “5DM-L” [made by San-ei Manufacturing Co., Ltd.], etc.}, or a Henschel mixer [made by Nippon Coke & Engineering Co., Ltd.], etc. may be used.

Examples of the fiber applicable to the fiber sizing agent composition (E) or the fiber sizing agent aqueous solution (S) of the invention include well-known inorganic fibers, such as glass fiber, carbon fiber, ceramic fiber, metallic fiber, mineral fiber, and slug fiber, etc. (e.g., the fiber mentioned in the pamphlet of WO2003/47830, etc.), and organic fibers such as aramid fiber, etc. From the viewpoint of strength of a molded article, carbon fiber is preferable. Two or more kinds of these fibers may be used in combination.

The fiber bundle of the invention bundles about 3,000 to 30,000 fibers together, and is obtained by processing at least one kind of fiber selected from the group consisting of these fibers by above fiber sizing agent composition (E) or fiber sizing agent aqueous solution (S).

The method of processing the fiber is exemplified by a spray method or an immersion method, etc. The deposition amount of the fiber sizing agent composition (E) onto the fiber is preferably 0.05 to 5 wt %, and more preferably 0.2 to 2.5 wt %, based on the weight of the fiber. If in this range, the sizing properties and the fiber spreading properties are excellent.

The composite intermediate of the invention is formed from the fiber bundle processed with the fiber sizing agent composition (E) or the fiber sizing agent aqueous solution (S) as described above or the above fiber product and a matrix resin. If necessary, a catalyst may also be included. If a catalyst is included, the strength of the molded article will be more excellent.

Examples of the matrix resin include: thermoplastic resins, such as polypropylene, polyamide, polyethylene terephthalate, polycarbonate, and polyphenylene sulfide, etc., and thermosetting resins, such as epoxy resin, unsaturated polyester resin, vinyl ester resin, and phenol resin, etc. Among them, the thermosetting resins are preferred, and epoxy resin, unsaturated polyester resin and vinyl ester resin are more preferred.

Examples of the catalyst for epoxy resin include well-known curing agents and curing accelerator for epoxy resin (mentioned in, e.g., Japan Patent Publication No. 2005-213337, etc.), etc. In addition, the catalyst for unsaturated polyester resin and vinyl ester resin is exemplified by a peroxide (benzoyl peroxide, t-butyl perbenzoate and t-butyl cumyl peroxide, etc., and methyl ethyl ketone peroxide, 1,1-di(t-butylperoxy)butane and di(4-t-butylcyclohexyl)peroxydicarbonate, etc.), or an azo-based compound (azobisisovaleronitrile, etc.).

From the viewpoint of the strength of the molded article, etc., the weight ratio of the matrix resin to the fiber bundle (matrix resin/fiber bundle) is preferably 10/90 to 90/10, more preferably 20/80 to 70/30, and particularly preferably 30/70 to 60/40. In cases where a catalyst is included, from the viewpoint of the strength of the molded article, etc., the content of the catalyst relative to the matrix resin is preferably 0.01 to 10 wt %, more preferably 0.1 to 5 wt %, and particularly preferably 1 to 3 wt %.

The composite intermediate may be fabricated by impregnating the fiber bundle or the fiber product with a thermally melted (melting temperature: 60-150° C.) matrix resin or a matrix resin diluted with a solvent (e.g., acetone, methyl ethyl ketone, methyl isobutyl ketone, toluene, xylene, and ethyl acetate, etc.). In cases where the solvent has been used, it is preferred to remove the solvent by drying the prepreg.

The fiber-reinforced composite material of the invention is obtained by molding the above composite intermediate. In cases where the matrix resin is a thermoplastic resin, the prepreg may be heat-molded and then solidified at normal temperature to form a molded article. In cases where the matrix resin is a thermosetting resin, the prepreg may be heat-molded and cured to form a molded article. Although it is not necessary to complete the curing, the molded article is preferably cured to an extent that its shape is maintained. It may also be completely cured by further heating after being molded. The method of heat-molding is not particularly limited, and may be, for example, a filament winding molding method (a heat-molding method by coiling around a rotating mandrel while applying a tension thereto), a press molding method (a heat-molding method by laminating a prepreg sheet), an autoclaving method (a heat-molding method by applying a pressure to push a prepreg sheet into a mold), and a method of mixing chopped fiber or milled fiber with a matrix resin and injection-molding the mixture, etc.

### EXAMPLES

The invention is described in further details below with examples. However, the invention is not limited thereto.

### Preparation Example 1

Polyester Resin (A2):

2,212 weight parts of an adduct of 2 moles of ethylene oxide to bisphenol A that was “Newpol BPE-20” produced by Sanyo Chemical Industries, Ltd., 996 weight parts of terephthalic acid [alcohol/acid=7/6 (molar ratio)] and 3 weight parts of potassium titanium oxalate were reacted in a glass reaction vessel at 230° C. for 15 hours while being decompressed to 0.001 MPa to distill water away. Then, 1,500 weight parts of a polyoxyethylene glycol “PEG1500” [produced by Sanyo Chemical Industries, Ltd.] were added, and the resultant was reacted at 180° C. at ordinary pressure for 10 hours, thereby obtaining 4,490 weight parts of the polyester resin (A2).

The viscosity of (A2) at 35° C. was 700 Pa·s.

The composition of the sizing agent (A), the thixotropy imparting agent (B) and the surfactant (C) used in the following examples is as follows.

Sizing Agent (A):

Bisphenol A epoxy resin (A1): “JER834” [by Mitsubishi Chemical Corporation]

Polyurethane emulsion (A3): “CHEMITYLEN GA-500” [viscosity at 35° C.: 55 Pa·s, a urethane emulsion of a polyester polyol and an aliphatic isocyanate, nonvolatile content: 50 wt %, produced by Sanyo Chemical Industries, Ltd.]

Polyether resin (A4): one prepared by randomly adding 10 moles of propylene oxide and 20 moles of ethylene oxide to 1 mole of bisphenol A.

Vinyl ester resin (A5): one prepared by esterifying 2 moles of methacrylic acid with 1 mole of the bisphenol A epoxy resin (A1).

Thixotropy Imparting Agent (B):

Higher fatty acid amide (B1): Stearic acid amide.

Fatty acid ester (B2): Hydrogenated castor oil [by Itoh Oil Chemicals, Co., Ltd.]

Fatty acid salt (B3): Lithium stearate [by Kawamura Kasei Industry Co., Ltd.]

Polyethylene oxide (B4): “Sanwax E-310” [acid value: 15 mgKOH/g, Mw: 2,000, produced by Sanyo Chemical Industries, Ltd.]

Surfactant (C):

Non-ionic surfactant (C1): one prepared by adding 20 moles of ethylene oxide to 1 mole of styrenated phenol

<Measurement of Viscosity of Sizing Agent (A) at 35° C.>

The viscosity of the sizing agent (A) used in the examples at 35° C. was set to an average of values measured twice under the following conditions. The results are shown in Table 1. Moreover, in cases where two or more kinds of (A) were used in combination, the viscosity of the mixture at 35° C. was measured.

Model: BH type viscometer [made by Toki Sangyo Co., Ltd.]

Measurement temperature: 35° C.

Rotor No.: 23

Rotational speed: 0.3 rpm

The viscosity after 20 minutes from the beginning of the measurement was read.

<Measurement of Thixotropic Index (TI) of Sizing Agent (E)>

The measurement of the TI of (E) used in the examples was performed as follows.

Model: BH type viscometer [made by Toki Sangyo Co., Ltd.]

Measurement temperature: 35° C.

Rotor No.: 23

E0.3 rpm: viscosity at the rotational speed of 0.3 rpm

E3 rpm: viscosity at the rotational speed of 3 rpm

The viscosity after 20 minutes from the beginning of the measurement was read.

(TI)=(E0.3 rpm)/(E3 rpm)

### Example 1

600 weight parts of the epoxy resin (A1), 200 weight parts of the higher fatty acid amide (B1), and 200 weight parts of the surfactant (C1) were put into a universal mixer [made by San-ei Manufacturing Co., Ltd.], homogeneously mixed at 130° C. for 30 min and then cooled to 50° C., thereby obtaining a fiber sizing agent composition (E1). Next, 1,500 weight parts of water were dripped in (E1) in 6 hours, thereby obtaining 2,500 weight parts of a fiber sizing agent aqueous solution (S-1) with a concentration of nonvolatile content of 40 wt %. The viscosity of (A1) at 35° C. was 55 Pa·s.

### Example 2

650 weight parts of the polyester resin (A2), 50 weight parts of the fatty acid ester (B2), 50 weight parts of the polyether resin (A4), and 200 weight parts of the surfactant (C1) were put into a universal mixer [made by San-ei Manufacturing Co., Ltd.], and homogeneously mixed at 50° C. for 30 min. Further, 1,450 weight parts of water were dripped therein in 6 hours, and 100 weight parts of the polyurethane emulsion (A3) were added, thereby obtaining 2,500 weight parts of a fiber sizing agent aqueous solution (S-2) having a concentration of nonvolatile content of 42 wt %. The viscosity of the component (A) [the nonvolatile content of the mixture of the above (A2), (A4) and (A3)] at 35° C. was 700 Pa·s.

### Example 3

700 weight parts of the vinyl ester resin (A5), 100 weight parts of the fatty acid salt (B3), and 200 weight parts of the surfactant (C1) were put into a universal mixer [made by San-ei Manufacturing Co., Ltd.], homogeneously mixed at 80° C. for 30 min and then cooled to 50° C., thereby obtaining a fiber sizing agent composition (E3). Next, 1,500 weight parts of water were dripped in (E3) in 6 hours, thereby obtaining 2,500 weight parts of a fiber sizing agent aqueous solution (S-3) with a concentration of the nonvolatile content of 40 wt %. The viscosity of (A5) at 35° C. was 2,800 Pa·s.

### Example 4

200 weight parts of the epoxy resin (A1), 400 weight parts of the polyethylene oxide (B4), 200 weight parts of the polyester resin (A2), and 200 weight parts of the surfactant (C1) were put into a universal mixer [made by San-ei Manufacturing Co., Ltd.], homogeneously mixed at 130° C. for 30 min and then cooled to 50° C., thereby obtaining a fiber sizing agent composition (E4). Next, 1,500 weight parts of water were dripped in (E4) in 6 hours, thereby obtaining 2,500 weight parts of a fiber sizing agent aqueous solution (S-4) having a concentration of nonvolatile content of 40 wt %. Moreover, the viscosity of the component (A) [the mixture of the above (A1) and (A2)] at 35° C. was 200 Pa·s.

### Example 5

850 weight parts of the polyester resin (A2) and 150 weight parts of the higher fatty acid amide (B1) were put into a universal mixer [made by San-ei Manufacturing Co., Ltd.], homogeneously mixed at 130° C. for 30 min and then cooled to 50° C., thereby obtaining a fiber sizing agent composition (E5). Next, 1,500 weight parts of water were dripped in (E5) in 6 hours to obtain 2,500 weight parts of a fiber sizing agent aqueous solution (S-5) having a concentration of nonvolatile content of 40wt %. The viscosity of (A2) at 35° C. was 600 Pa·s.

### Example 6

300 weight parts of the epoxy resin (A1), 500 weight parts of the polyester resin (A2), 50 weight parts of the higher fatty acid amide (B1), and 150 weight parts of the surfactant (C1) were put into a universal mixer [made by San-ei Manufacturing Co., Ltd.], homogeneously mixed at 130° C. for 30 min and then cooled to 50° C., thereby obtaining a fiber sizing agent composition (E6). Next, 1,500 weight parts of water were dripped in (E6) in 6 hours, thereby obtaining 2,500 weight parts of a fiber sizing agent aqueous solution (S-6) having a concentration of nonvolatile content of 40 wt %.

Moreover, the viscosity of the component (A) [the mixture of the above (A1) and (A2)] at 35° C. was 330 Pa·s.

### Comparative Example 1

800 weight parts of the epoxy resin (A1) and 200 weight parts of the surfactant (C1) were put into a universal mixer [made by San-ei Manufacturing Co., Ltd.], homogeneously mixed at 80° C. for 30 min and then cooled to 50° C., and 1,500 weight parts of water were dripped therein in 6 hours, thereby obtaining 2,500 weight parts of a fiber sizing agent aqueous solution (S′1) having a concentration of nonvolatile content of 40 wt %.

### Comparative Example 2

200 weight parts of the higher fatty acid amide (B1) and 750 weight parts of the polyether resin (A4) were put into a universal mixer [made by San-ei Manufacturing Co., Ltd.], homogeneously mixed at 130° C. for 30 min and then cooled to 50° C., 1,450 weight parts of water were dripped therein in 6 hours, and 100 weight parts of the polyurethane emulsion (A3) were further added, thereby obtaining 2,500 weight parts of a fiber sizing agent aqueous solution (S′2) having a concentration of nonvolatile content of 42 wt %. The viscosity of the component (A) [the nonvolatile content of (A4) and (A3)] at 35° C. was 40 Pa·s.

### Comparative Example 3

200 weight parts of the higher fatty acid amide (B1), 100 weight parts of the polyether resin (A4), and 200 weight parts of the surfactant (C1) were put into a universal mixer [made by San-ei Manufacturing Co., Ltd.], and homogeneously mixed at 30° C. for 30 min. Further, the resultant was cooled to 50° C., 1,000 weight parts of water were dripped therein in 6 hours, and then 1,000 weight parts of the polyurethane emulsion (A3) were added, thereby obtaining 2,500 weight parts of a fiber sizing agent aqueous solution (S′3) having a concentration of nonvolatile content of 60 wt %. The viscosity of the component (A) [the nonvolatile content of (A4) and (A3)] at 35° C. was 3,300 Pa·s.

### Comparative Example 4

500 weight parts of the higher fatty acid amide (B1), 100 weight parts of the polyether resin (A4), and 100 weight parts of the surfactant (C1) were put into a universal mixer [made by San-ei Manufacturing Co., Ltd.], and homogeneously mixed at 30° C. for 30 minutes. Further, the resultant was cooled to 50° C., 1,200 weight parts of water were dripped therein for 6 hours, and 600 weight parts of the polyurethane emulsion (A3) were further added thereto, thereby obtaining 2,500 weight parts of a fiber sizing agent aqueous solution (S′4) having a concentration of the nonvolatile content of 52 wt %. The viscosity of the component (A) [(A4) and the nonvolatile content of (A3)] at 35° C. was 2,100 Pa·s.

The fiber sizing agent compositions in the fiber sizing agent aqueous solutions (S1) to (S6) and (S′1) to (S′6) were diluted with water so that their respective active ingredients account for 1.5 wt %. With respect to a carbon fiber bundle (having a fiber bundle width of about 7 mm) obtained by impregnating unprocessed carbon fiber (having a fineness of 800 tex and a filament number of 12,000) with this diluting fluid for 1 hour and hot-air drying the same at 150° C. for 3 min, the sizing properties and the fiber spreading properties were evaluated by the following method. The results are shown in Table 1.

<Evaluation of Sizing Properties>

30 cm of the carbon fiber bundle obtained by the above method was stretched straight on a stand, and was then made protruding from an end of the stand, wherein the length of protrusion until the carbon fiber bundle bends was measured. A greater numerical value means that the sizing properties are excellent.

<Evaluation of Fiber Spreading Properties>

Five smooth-surfaced stainless rods having a diameter of 10 mm were arranged parallel to one another with a spacing of 50 mm between them and in a zigzag manner so that the carbon fiber bundle passes therethrough in contact therewith at an angle of 120 degrees. The carbon fiber bundle obtained by the above method was set in a zigzag manner between the stainless rods. After the carbon fiber bundle was wound from a feed roll to a wind-up roll with a tension of 1,000 g between the feed roll and the wind-up roll at a speed of 1 m/min, and passed through the five stainless rods, the expansion width (mm) of the carbon fiber bundle was measured by a “yarn running test apparatus” [made by Asano Kikai Seisakusho K.K.]. A greater numerical value means that the fiber spreading properties are excellent.

<Index of Grade>

The product of the sizing properties and the fiber spreading properties was set as an index of grade. A greater numerical value means that the sizing properties and the fiber spreading properties are both excellent.

<Evaluation of Appearance of Composite Intermediate>

Ten 50 cm-carbon fiber bundles obtained by the above method were arranged in parallel to form a sheet shape, and a bisphenol A epoxy resin “JER828” [by Mitsubishi Chemical Corporation] having the same weight of the carbon fiber bundles was applied thereover. After 2 minutes of heating at 100° C., whether there is any spotted pattern caused by uneven impregnation was determined by eyes. One without such pattern was denoted by “◯”, while one with such pattern was denoted by “×”.

<Evaluation of Flexural Strength of Fiber-Reinforced Composite Material>

The carbon fiber bundle obtained by the above method was arranged in one direction and put into a mold (a frame-type mold of 10 cm long, 10 cm wide and 2 mm thick). Then, a matrix resin [prepared by mixing 100 weight parts of the bisphenol A epoxy resin “JER828” with 3 weight parts of BF₃ monoethylamine salt] was added, and the resultant was impregnated under a reduced pressure (0.0065 MPa). At this moment, the amount of the carbon fiber bundle was adjusted such that the volume content of the carbon fiber bundle became 60%. Next, the resultant was cured at 150° C. under an increased pressure (0.49 MPa) for 1 hour. Further, the temperature was reduced to 140° C., and the curing was performed under the increased pressure (0.49 MPa) for 4 hours. The obtained cured product was cut off using a diamond cutter to produce a test piece of 2 mm thick, 10 mm wide and 100 mm long. The flexural strength (ratio of span/thickness=32, test speed=5.0 mm/min) was measured in accordance with JIS K7074. A greater numerical value means that the flexural strength is excellent.

TABLE 1

| | | Aqueous | | | | | | | | | | |
|---|---|---|---|---|---|---|---|---|---|---|---|---|
| | | solution | Composition, Nonvolatile content (wt %) | | | | | | | | | |
| | | of fiber | Sizing agent (A) | | | | | Thixotropy imparting agent (B) | | | | Surfactant (C) |
| | | sizing agent | (A1) | (A2) | (A3) | (A4) | (A5) | (B1) | (B2) | (B3) | (B4) | (C1) |
| Example | 1 | (S-1) | 60 | — | — | — | — | 20 | — | — | — | 20 |
| | 2 | (S-2) | — | 61 | 5 | 10 | — | — | 5 | — | — | 19 |
| | 3 | (S-3) | — | — | — | — | 70 | — | — | 10 | | 20 |
| | 4 | (S-4) | 20 | 20 | — | — | — | — | — | — | 40 | 20 |
| | 5 | (S-5) | | 85 | — | — | — | 15 | — | — | — | — |
| | 6 | (S-6) | 30 | 50 | — | — | — | 5 | — | — | — | 15 |
| Comparative | 1 | (S′-1) | 80 | — | — | — | — | — | — | — | — | 20 |
| Example | 2 | (S′-2) | — | — | 10 | 71 | — | 19 | — | — | — | — |
| | 3 | (S′-3) | — | — | 67 | 7 | — | 13 | — | — | — | 13 |
| | 4 | (S′-4) | — | — | 46 | 8 | — | 38 | — | — | — | 8 |

| | | | Viscosity | | | Fiber | | | Flexural strength of |
|---|---|---|---|---|---|---|---|---|---|
| | | | of (A) | Content | Sizing | spreading | Index | Appearance | fiber-reinforced |
| | | | (Pa · s at | of (B) | properties | properties | of | of composite | composite material |
| | | TI | 35° C.) | (wt %) | (cm) | (mm) | grade | intermediate | (MPa) |
| Example | 1 | 4.3 | 55 | 20 | 9.3 | 13.7 | 127.4 | ∘ | 950 |
| | 2 | 3.2 | 700 | 5 | 13.1 | 12.2 | 159.8 | ∘ | 980 |
| | 3 | 5.6 | 2800 | 10 | 14.8 | 9.5 | 140.6 | ∘ | 880 |
| | 4 | 14.7 | 200 | 40 | 12.1 | 13.1 | 158.5 | ∘ | 920 |
| | 5 | 6.2 | 600 | 15 | 12.7 | 12.4 | 157.5 | ∘ | 950 |
| | 6 | 3.7 | 330 | 5 | 13.4 | 12.1 | 162.1 | ∘ | 980 |
| Comparative | 1 | 1.1 | 55 | 0 | 8.5 | 11.7 | 99.5 | ∘ | 790 |
| Example | 2 | 3.4 | 40 | 19 | 7.5 | 13.1 | 98.3 | ∘ | 770 |
| | 3 | 8.5 | 3300 | 13 | 16.1 | 4.5 | 72.5 | x | 730 |
| | 4 | 16.5 | 2100 | 38 | 19.2 | 2.1 | 40.3 | x | 520 |

It is clear from Table 1 the the fiber bundle obtained by processing with the fiber sizing agent composition (E) of the invention is excellent in both sizing properties and fiber spreading properties. As indicated by the comparative examples, so far there is no fiber bundle excellent in both sizing properties and fiber spreading properties.

In order to clarify the excellence in both sizing properties and fiber spreading properties, the index of grade was mentioned in Table 1. The index of grade is the product of the numerical values of the sizing properties and the fiber spreading properties. If this numerical value is higher than 100, it indicates that the sizing properties and the fiber spreading properties are both excellent. As indicated by the comparative examples, in conventional fiber sizing agent compositions, the numerical value of this index was less than 100.

Any one of the fiber bundles obtained by processing with the fiber sizing agent composition (E) of the invention achieved an index of grade more than 120, so it is clear that the fiber sizing agent composition (E) is an excellent fiber sizing agent composition that has not existed hitherto.

### INDUSTRIAL UTILITY

The fiber-reinforced composite material obtained by molding the composite intermediate obtained from the fiber bundle of the invention and matrix resin may be suitably applied to various construction and building materials, materials for transport aircrafts, materials for sports appliances, and materials for power generators, etc.

1. A fiber sizing agent composition (E), comprising a sizing agent (A) having a viscosity of 50 to 3,000 Pa·s at 35° C., and having a thixotropic index of 3 to 15.

2. The fiber sizing agent composition (E) of claim 1, further comprising a thixotropy imparting agent (B).

3. The fiber sizing agent composition (E) of claim 1, wherein the sizing agent (A) is one or more selected from the group consisting of an epoxy resin, a polyester resin, a polyurethane resin, a polyether resin and a vinyl ester resin.

4. The fiber sizing agent composition (E) of claim 2, wherein the thixotropy imparting agent (B) is one or more selected from the group consisting of a fatty acid amide, a fatty acid ester, a fatty acid salt and a polyolefin oxide.

5. The fiber sizing agent composition (E) of claim 2, wherein a content of the thixotropy imparting agent (B) is 3 to 30 wt % relative to a weight of (E).

6. A fiber sizing agent aqueous solution (S) obtained by dissolving or dispersing the fiber sizing agent composition (E) of claim 1 in an aqueous medium.

7. A fabricating method of a fiber bundle, characterized by processing a fiber using the fiber sizing agent composition (E) of claim 1.

8. The fabricating method of a fiber bundle of claim 7, wherein the fiber is one or more selected from the group consisting of a carbon fiber, a glass fiber, an aramid fiber, a ceramic fiber, a metallic fiber, a mineral fiber and a slag fiber.

9. A fiber bundle obtained by the fabricating method of claim 7.

10. A composite intermediate obtained by the fiber bundle of claim 9 and a matrix resin.

11. A fiber-reinforced composite material obtained by molding the composite intermediate of claim 10.

12. A fiber sizing agent aqueous solution (S) obtained by dissolving or dispersing the fiber sizing agent composition (E) of claim 2 in an aqueous medium.

13. A fabricating method of a fiber bundle, characterized by processing a fiber using the fiber sizing agent composition (E) of the fiber sizing agent aqueous solution (S) of claim 6.

14. A fabricating method of a fiber bundle, characterized by processing a fiber using the fiber sizing agent composition (E) of the fiber sizing agent aqueous solution (S) of claim 12.

15. A fiber bundle obtained by the fabricating method of claim 13.

16. A fiber bundle obtained by the fabricating method of claim 14.

17. A composite intermediate obtained by the fiber bundle of claim 15 and a matrix resin.

18. A composite intermediate obtained by the fiber bundle of claim 16 and a matrix resin.

19. A fiber-reinforced composite material obtained by molding the composite intermediate of claim 17.

20. A fiber-reinforced composite material obtained by molding the composite intermediate of claim 18.
